(19) United States
(12) Patent Application Publication
(10) Pub. No.: US 2014/0358452 A1
(43) Pub. Date: Dec. 4, 2014

(54) METHOD FOR ESTIMATING CRACK LENGTH PROGRESSIONS

(71) Applicant: SIEMENS AKTIENGESELLSCHAFT, Munchen (DE)

(72) Inventors: Christian AMANN, Bottrop (DE); Kai KADAU, Lake Wylie, SC (US)

(73) Assignee: SIEMENS AKTIENGESELLSCHAFT, Munchen (DE)

(21) Appl. No.: 14/282,081

(22) Filed: May 20, 2014

(30) Foreign Application Priority Data
May 29, 2013 (EP) 13169639

(51) Int. Cl. G01M 15/14; G06F 17/11

(52) U.S. Cl. CPC G01M 15/14; G06F 17/11
USPC 702/35

(57) ABSTRACT

A method for estimating the crack length ãₙ₊₁ of at least one crack (2) in a component (1): At a first instant, the length ãₙ of the crack is determined and the length of the crack ãₙ₊₁=ãₙ+Δãₙ is estimated at a second instant by using the integration scheme

$$\begin{matrix}{\tilde{a}}_{n + 1} = {\tilde{a}}_{n} + \frac{d {\tilde{a}}_{1}}{6} + \frac{d {\tilde{ a}}_{2}}{3} + \frac{d {\tilde{a}}_{3}}{3} + \frac{d {\tilde{a}}_{4}}{6} & ( 17 ) \\ d {\tilde{a}}_{1} = d Nf ( Δ {K}_{n} ) & ( 18 ) \\ d {\tilde{a}}_{2} = d Nf ( Δ {K}_{n} + \frac{1}{2} \frac{Δ {K}_{n}}{2 {\tilde{a}}_{n}} d {\tilde{a}}_{1} ) & ( 19 ) \\ d {\tilde{a}}_{3} = d Nf ( Δ {K}_{n} + \frac{1}{2} \frac{Δ {K}_{n}}{2 {\tilde{a}}_{n}} d {\tilde{a}}_{2} ) & ( 20 ) \\ d {\tilde{a}}_{4} = d Nf ( Δ {K}_{n} + \frac{Δ {K}_{n}}{2 {\tilde{a}}_{n}} d {\tilde{a}}_{3} ) , & ( 21 )\end{matrix}$$

with Δãₙ designating the increase in the crack size, N designating the number of cycles, and K designating the stress intensity factor.

### CROSS-REFERENCE TO RELATED APPLICATIONS

The present application claims priority of European Patent Application No. EP 13169639, filed May 29, 2013, the contents of which are incorporated by reference herein. The European Application was published in the German language.

### TECHNICAL FIELD

The present invention relates to a method for estimating the crack length of a crack in a component, to a method for determining the probability of failure of a component, and to the use of such a method in the context of the probabilistic fracture mechanics evaluation or fracture mechanics estimation. The invention further relates to a method for operating a turbine.

### TECHNICAL BACKGROUND

In many technical and structural applications, expanding cracks or defects in components are limiting factors for the operating period and the service life of the respective components. This applies, in particular, to components which are subjected to cyclic loads, that is to say, for example, are exposed to temporally oscillating thermal and/or mechanical loads. By way of example, components of turbine systems such as, in particular, in gas turbines or steam turbines are subjected to temporally varying thermal stresses during the startup or the shutdown of the turbine.

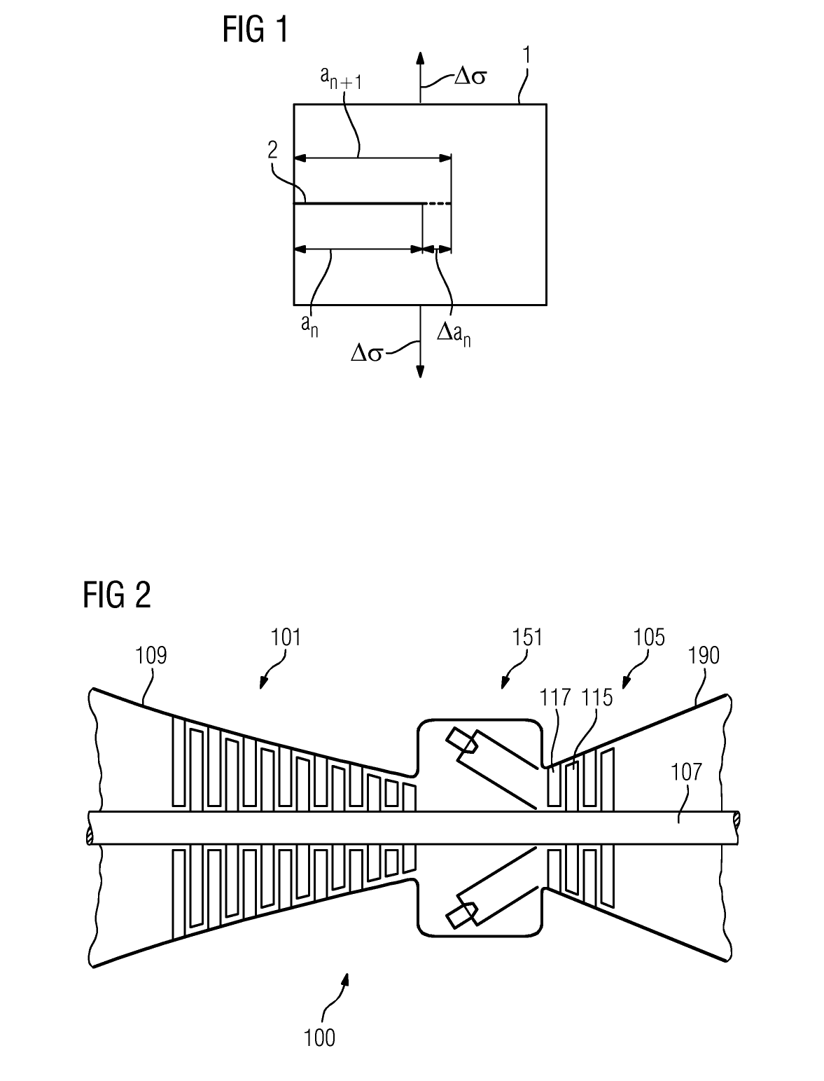

The service life of such a component can be estimated in many cases with the aid of a determination or estimation of the crack growth. Various types of crack openings are typically distinguished for this purpose. An example of this is the type I crack opening or mode I (mode I crack growth), in which the crack opening takes place perpendicularly to the crack surface. FIG. 1 shows an example of this.

FIG. 1 is a schematic of a component 1 having a crack 2. A stress acts perpendicular to the crack surface 2. The change in the acting stress Ac is marked by arrows in FIG. 1. Component 1, shown by way of example in FIG. 1, has a rectangular or cubic structure or a rectangular or cubic surface. The component can have any desired shape in principle.

The crack 2 firstly had a length aₙ. Owing to the stress σ, the length of the crack 2 increases in accordance with a specific stress or a specific operating period to aₙ₊₁=aₙ+Δaₙ. The crack opening perpendicular to the crack surface (mode I) takes place at a crack opening rate

$$\frac{da}{dN} ,$$

N denoting the cycles run through. The crack opening rate is typically characterized as a function f of a range of the stress intensity ΔK. On the basis of an exponential dependence, the following Paris-Erdogan equation is obtained:

$$\frac{da}{dN} = f ( Δ K ) = C Δ {K}^{m} . \qquad ( 1 )$$

Here, a denotes the crack length, N denotes the number of cycles, and ΔK denotes the range of the stress intensity considered. C and m are material constants.

A large number of crack progression calculations must be carried out when calculating probabilities of failure in the context of a probabilistic fracture mechanics evaluation. Typical integration methods for calculating the crack size require small integration step widths in order to deliver a converging solution. These methods cannot deliver conservative solutions for the crack length when there are excessively large step widths. The small integration step widths can have the effect that the calculation times become so large that it is no longer possible in a practical manner in terms of time to carry out a large number of calculations.

### SUMMARY OF THE INVENTION

It is an object of the present invention to make available a method for estimating the crack length of a crack in a component, said method delivering reliable conservative solutions for the crack length and simultaneously enabling the integration step widths to be increased. A further object of the present invention consists in making available an advantageous method for determining the probability of failure of a component, and an advantageous use of such a method in the context of a probabilistic fracture mechanics evaluation or fracture mechanics estimation. In addition, one object of the invention is to make available an advantageous method for operating a turbine.

The first object is achieved by a method for estimating the crack length of a crack in a component in accordance with the invention. The second object is achieved by a method for determining the probability of failure of a component in accordance with the invention. The third object is achieved by a use of one of the above named methods for determining the probability of failure of a component in the context of a probabilistic fracture mechanics evaluation in accordance with the invention. The fourth object is achieved by a method for operating a turbine in accordance with the invention.

The inventive method for estimating, in particular conservative estimating, the crack length ãₙ₊₁ of at least one crack in a component comprises the following steps:
at a first instant, the length ãₙ of the crack is determined, in particular measured. The length of the crack ãₙ₊₁=ãₙ+Δãₙ is estimated at a second, in particular determinable later, instant by using the integration scheme

$$\begin{matrix}{\tilde{a}}_{n + 1} = {\tilde{a}}_{n} + \frac{d {\tilde{a}}_{1}}{6} + \frac{d {\tilde{ a}}_{2}}{3} + \frac{d {\tilde{a}}_{3}}{3} + \frac{d {\tilde{a}}_{4}}{6} & ( 17 ) \\ d {\tilde{a}}_{1} = d Nf ( Δ {K}_{n} ) & ( 18 ) \\ d {\tilde{a}}_{2} = d Nf ( Δ {K}_{n} + \frac{1}{2} \frac{Δ {K}_{n}}{2 {\tilde{a}}_{n}} d {\tilde{a}}_{1} ) & ( 19 ) \\ d {\tilde{a}}_{3} = d Nf ( Δ {K}_{n} + \frac{1}{2} \frac{Δ {K}_{n}}{2 {\tilde{a}}_{n}} d {\tilde{a}}_{2} ) & ( 20 ) \\ d {\tilde{a}}_{4} = d Nf ( Δ {K}_{n} + \frac{Δ {K}_{n}}{2 {\tilde{a}}_{n}} d {\tilde{a}}_{3} ) , & ( 21 )\end{matrix}$$

with Δãₙ designating the increase in the crack size, N designating the number of cycles, and K designating the stress intensity factor.

The inventive method has the advantage that it enables a conservative estimation of the crack size even given very large integration step widths. Owing to the conservative crack size calculation in conjunction with large integration step widths, it is possible to carry out a quick prescreening of the crack sizes to be calculated, and to reduce the number of cracks which must be calculated with high precision.

The inventive method uses a modified Runge-Kutta algorithm which delivers larger crack sizes by comparison with the classic Runge-Kutta 4^{th} order algorithm and, in addition, when integration step widths dN become smaller, converges to the regular Runge-Kutta scheme, and thus to the exact solution for the crack size.

Within the scope of the inventive method, the stress intensity factor can be determined by means of experimentally determined, for example interpolated, measured data. For example, the stress intensity factor can be determined by means of a geometry factor Y(a) and a stress σ. A range of the stress intensity factor ΔK can be determined by means of the geometry factor Y(a) and a stress range Δσ in accordance with

ΔK=Δσ\sqrt{πa}Y(a) (2).

In addition, within the scope of the inventive method the function f can be defined as a positively monotonically increasing function and/or the crack length a can be defined as greater than or equal to zero a≧0, and/or the geometry factor Y can be defined as greater than or equal to zero Y≧0, and/or the stress range Lo can be defined as greater than or equal to zero Δσ≧0.

The crack length of a crack in a component of a gas turbine, for example the crack length of a crack in a component of the rotor of a gas turbine, can preferably be estimated. The component of the rotor can preferably be a turbine blade, for example a guide blade or a moving blade, or a shaft.

The inventive method for determining, for example for calculating, the probability of failure of a component is distinguished by the fact that the crack length of a crack in the component is estimated by means of the previously described method, and the probability of failure of the component is determined on the basis of the estimated crack length.

Within the scope of the inventive use, one of the above-described methods is employed to determine, in particular to calculate, the probability of failure of a component in the context of a probabilistic fracture mechanics evaluation or fracture mechanics estimation of the component. The terms fracture mechanics evaluation and fracture mechanics estimation are used synonymously within the scope of the present invention and in essence embody an objective evaluation of the properties of the respective component.

The inventive method for determining the probability of failure of a component, and the inventive use of one of the above named methods have essentially the same advantages as the inventive method for estimating the crack length.

The inventive method for operating a turbine comprises the following steps: at least one component of the turbine is inspected for the presence of at least one crack or defect. If a crack or defect is determined, the initial length of the crack or defect is determined. The length of the crack is estimated at a second instant, in particular a determinable later instant, in accordance with the above-described method. If the estimated crack length reaches or exceeds a defined value, the component is replaced and/or repaired at a defined point in time.

If the estimated crack length reaches or exceeds a defined selection value, the selection value being less than the limit value, the crack or defect can additionally be subjected to a more accurate inspection or estimation of the crack length. A more accurate estimation can take place, for example, with the aid of the above-described method by using smaller integration steps.

The inspection of the component for cracks or defects can, for example, be performed with the aid of optical or acoustic methods. The turbine can be a gas turbine or a steam turbine.

The point in time at which the component is repaired and/or replaced is preferably later than the second point in time determined in the context of the estimation of the crack size. In principle, it suffices within the scope of the present invention when the second or later point in time can be determined, that is to say, for example, after a specific number of defined operating cycles of the machine comprising the component is reached. The second point in time therefore need not be defined from the start in the form of a particular datum or a determined time of day.

Within the scope of the inventive method for operating a turbine, it is also possible to apply the above-described method for determining the probability of failure of a component, and/or the use of the method described for determining the probability of failure of a component in the context of a probabilistic fracture mechanics evaluation or fracture mechanics estimation of the component.

For many applications, the crack size as such is of subordinate interest. The decisive information comprises whether the crack is smaller than a specific critical size after a prescribed number of cycles, for example specific operating cycles or a specific operating period or operating load of a machine such as, for example, a gas turbine, has been run through. Against this background, the present invention is advantageous in the sense that in the course of carrying out the described method the crack size is overestimated or estimated to be too high, and finally converges to the exact crack size when use is made of small step sizes.

In addition, the previously described inventive methods can be used to sharply reduce the time required to carry out a probabilistic fracture mechanics evaluation, in particular the time for determining and calculating the progression of the crack formation. The inventive methods can be used, in particular, to assess and select existing cracks according to which of the cracks must be inspected in more detail at all. As a rule, only a small proportion of the cracks is constituted such that a more detailed inspection is required. Said cracks, which may cause a failure or a destruction of the component, can subsequently be inspected in more detail by using smaller integration step sizes.

Further features, advantages and properties of the present invention are described here in the following with the aid of exemplary embodiments. All features described previously and in what follows can be used in this case in any desired combination with one another. The following description for the exemplary embodiments does not constitute a limitation of the present invention.

FIG. 1 is a schematic of a component having an expanding crack,

FIG. 2 is a schematic of a gas turbine.

### DESCRIPTION OF EMBODIMENTS

FIG. 1 has already been explained in the course of the introduction to the description, and so reference is made in this regard to the statements made above.

The basis for the estimation of the crack size in accordance with the inventive method is the classic 4^{th} order Runge-Kutta algorithm:

$$\begin{matrix}{a}_{n + 1} = {a}_{n} + Δ {a}_{n} & ( 9 ) \\ {a}_{n + 1} = {a}_{n} + \frac{d {a}_{1}}{6} + \frac{d {a}_{2}}{3} + \frac{d {a}_{3}}{3} + \frac{d {a}_{4}}{6} & ( 10 ) \\ d {a}_{1} = d Nf ( Δ σ Y ( a ) \sqrt{π {a}_{n}} ) & ( 11 ) \\ d {a}_{2} = d Nf ( Δ σ Y ( a ) \sqrt{π ( {a}_{n} + \frac{1}{2} d {a}_{1} )} ) & ( 12 ) \\ d {a}_{3} = d Nf ( Δ σ Y ( a ) \sqrt{π ( {a}_{n} + \frac{1}{2} d {a}_{2} )} ) & ( 13 ) \\ d {a}_{4} = d Nf ( Δ σ Y ( a ) \sqrt{π ( {a}_{n} + d {a}_{3} )} ) . & ( 14 )\end{matrix}$$

The number of cycles N and the crack length progress by the integration step dN in each integration cycle.

The following integration scheme is used in the context of the inventive method:

$$\begin{matrix}{\tilde{a}}_{n + 1} = {\tilde{a}}_{n} + \frac{d {\tilde{a}}_{1}}{6} + \frac{d {\tilde{ a}}_{2}}{3} + \frac{d {\tilde{a}}_{3}}{3} + \frac{d {\tilde{a}}_{4}}{6} & ( 17 ) \\ d {\tilde{a}}_{1} = d Nf ( Δ {K}_{n} ) & ( 18 ) \\ d {\tilde{a}}_{2} = d Nf ( Δ {K}_{n} + \frac{1}{2} \frac{Δ {K}_{n}}{2 {\tilde{a}}_{n}} d {\tilde{a}}_{1} ) & ( 19 ) \\ d {\tilde{a}}_{3} = d Nf ( Δ {K}_{n} + \frac{1}{2} \frac{Δ {K}_{n}}{2 {\tilde{a}}_{n}} d {\tilde{a}}_{2} ) & ( 20 ) \\ d {\tilde{a}}_{4} = d Nf ( Δ {K}_{n} + \frac{Δ {K}_{n}}{2 {\tilde{a}}_{n}} d {\tilde{a}}_{3} ) . & ( 21 )\end{matrix}$$

The crack size a or crack length a constitutes a discrete crack length for each intermediate step of the integration steps in equations (10) to (14). The crack length is designated as a in equations (18) to (21). Since the crack length a represents a monotonically increasing function, the stress intensity is overestimated in the context of the inventive method by comparison with a classic Runge-Kutta integration in accordance with equations (10) to (14). This has the advantage that reaching the respective critical crack length can be estimated in advance in good time in each case, that is to say even before the crack has actually reached the critical crack size.

It is shown in the following that the modified Runge-Kutta algorithm used in the context of the inventive method leads to larger crack sizes in comparison to a classic 4^{th} order Runge-Kutta algorithm, and with smaller integration steps dN approximates the classic Runge-Kutta scheme, and thus the exact solution.

It is assumed that f is a positive monotonically increasing function, the crack length is a≧0, the geometry factor is Y≧0, and the stress range is Δσ≧0. In general, these boundary conditions or restrictions are met in the case of age-related crack growth. In addition, the initial crack sizes are set to be equally large, specifically a₀≡ã₀, for the purpose of comparing the two algorithms.

Equations (10) and (17) are identical up to the different designations of the crack length (a→ã). Equations (11) and (18) are likewise identical, only ΔK having been substituted in accordance with equation (2). The equations for da₂, da₃ and da₄ differ from the equations for dã₂, dã₃ and dã₄.

In order to demonstrate that ãₙ₊₁≧aₙ₊₁, it is necessary to consider the individual summands. Since dN is identical in both integration schemes, and f is a positive monotonically increasing function, all that needs to be done is to analyze the ratios of the respective arguments in equations (12) and (19), (13) and (20), and (14) and (21).

The first step is to examine the ratio of the arguments of equations (12) and (19) and demonstrate the following inequality:

$$\frac{Δ σ Y \sqrt{π ( {a}_{0} + \frac{1}{2} d {a}_{1} )}}{Δ {K}_{0} + \frac{1}{2} \frac{Δ {K}_{0}}{2 {a}_{0}} d {\tilde{a}}_{1}} \leq 1. \qquad ( 22 )$$

Here, ΔK was substituted with the aid of equation (2).

$$\frac{\sqrt{{a}_{0} + \frac{1}{2} d {a}_{1}}}{\sqrt{{a}_{0}} ( 1 + \frac{d {\tilde{a}}_{1}}{4 {a}_{0}} )} \leq 1. \qquad ( 23 )$$

All the values are positive, and the root has no influence on the inequality.

$$\frac{16 {a}_{0}^{2} + 8 {a}_{0 } d {a}_{1}}{16 {a}_{0}^{2} + 8 {a}_{0 } d {\tilde{a}}_{1} + d {\tilde{a}}_{1}^{2}} \leq 1. \qquad ( 24 )$$

As already mentioned, da₁=dã₁, and this demonstrates the inequality (24). The argument of the function in the modified Runge-Kutta algorithm is greater by dã₁² than in the classic Runge-Kutta algorithm. Since f is a monotonically increasing function, it holds that da₂≦dã₂ and dã₂ converges to da₂ as dN becomes smaller.

Similar analyses can be carried out for equations (13) and (20), and for equations (14) and (21). Since all the summands of equation (17) are greater than or equal to the corresponding summands of equation (10), the sum of the modified algorithm (17) is also greater than or equal to the sum of the classic 4^{th} order Runge-Kutta algorithm.

It can be shown in a similar way that as the integration steps dN become smaller, the crack sizes ãₙ₊₁ estimated by means of the modified Runge-Kutta algorithm converge to aₙ₊₁ as long as ∥f(ΔK)∥<∞. Consequently, the classic 4^{th} order Runge-Kutta algorithm converges to the correct result, and thus so does the modified algorithm used in the context of the inventive method.

The inventive method can be used, for example, to determine, in particular calculate, the crack size of one or more cracks in a component of a gas turbine, for example the rotor or components thereof.

FIG. 2 is a schematic of a gas turbine 100. In its interior, a gas turbine 100 has a rotor, mounted to rotate about an axis of rotation, with a shaft 107, which rotor is also denoted as a turbine runner. Following one another along the rotor are an intake housing 109, a compressor 101, a burner arrangement 15, a turbine 105 and the exhaust gas housing 190.

The burner arrangement 15 communicates with a hot gas duct, for example an annular one. There, a plurality of turbine stages connected one after another form the turbine 105. Each turbine stage is formed from blade rings. Viewed in the flow direction of a work medium, there follows in the hot gas duct of a row 117 of guide blades a row formed from moving blades 115. The guide blades 117 are fastened in this case on an inner housing of a stator, whereas the moving blades 115 in a row are located on the rotor by means of a turbine disk, for example. A generator or a work machine is coupled to the rotor.

During the operation of the gas turbine, the compressor 101 takes in air through the intake housing 109 and compresses it. The compressed air made available at the end of the compressor 101 on the turbine side is guided to the burner arrangements 15 and mixes with a fuel there. The mixture is then burnt in the combustion chamber with the formation of the work medium. From there, the work medium flows along the hot gas duct past the guide blades 117 and the moving blades 115. At the moving blades 115, the work medium expands in an impulse-transmitting fashion such that the moving blades 115 drive the rotor and the latter drives the work machine coupled thereto.

The component to be inspected in the context of the inventive method can, for example, be the shaft 107, one or more guide blades 117, or one or more moving blades 115. In order to carry out the inventive method, at a first instant, the length ãₙ of the crack to be inspected is determined, for example measured. Subsequently, the length of the crack ãₙ₊₁=ãₙ+Δãₙ is estimated at a second, preferably later instant by using the integration scheme

$$\begin{matrix}{\tilde{a}}_{n + 1} = {\tilde{a}}_{n} + \frac{d {\tilde{a}}_{1}}{6} + \frac{d {\tilde{ a}}_{2}}{3} + \frac{d {\tilde{a}}_{3}}{3} + \frac{d {\tilde{a}}_{4}}{6} & ( 17 ) \\ d {\tilde{a}}_{1} = d Nf ( Δ {K}_{n} ) & ( 18 ) \\ d {\tilde{a}}_{2} = d Nf ( Δ {K}_{n} + \frac{1}{2} \frac{Δ {K}_{n}}{2 {\tilde{a}}_{n}} d {\tilde{a}}_{1} ) & ( 19 ) \\ d {\tilde{a}}_{3} = d Nf ( Δ {K}_{n} + \frac{1}{2} \frac{Δ {K}_{n}}{2 {\tilde{a}}_{n}} d {\tilde{a}}_{2} ) & ( 20 ) \\ d {\tilde{a}}_{4} = d Nf ( Δ {K}_{n} + \frac{Δ {K}_{n}}{2 {\tilde{a}}_{n}} d {\tilde{a}}_{3} ) . & ( 21 )\end{matrix}$$

A multiplicity of cracks can first of all be advantageously inspected with little outlay, that is to say by using large integration step widths, with respect to the progression of the individual crack sizes. After said first estimate the cracks whose crack size according to the result of the first estimate exceeds a previously defined limit value for uncritical crack sizes are subjected to a further, more accurate inspection. This can be performed, for example, by a further estimation using the previously described algorithm with smaller integration step widths than in the case of the first estimation.

A method for the probabilistic estimation or evaluation of fracture mechanics or of the service life of each component, for example a component of a gas turbine, can comprise the following steps, for example: a number of potential defects or cracks of the component are defined on the basis of measured variation data with reference to the material properties and of measured variation data with reference to defects. In this case, each potential defect is defined with the aid of a possible material property and a feature for the defect size or crack size with reference to the component.

The position of each potential defect on the component is determined, and it is determined whether said defect could lead to the failure of the component after a prescribed number of cycles, for example operating cycles of the machine comprising the component, on the basis of crack progression calculations. The crack progression calculations can be performed on the basis of the material properties of the component and the properties of the defect or the crack. A failure of the component is assumed when the defect growth or crack growth has been determined as having an unstable trend. The total number of the potential defects which could lead to failure after a specific number N of cycles is determined. The probability of failure of the component is therefore determined after N cycles.

1. A method for estimating the crack length ãₙ₊₁ of at least one crack in a component comprising the following steps:
at a first instant, determining the length ãₙ of the crack; and
at a second instant estimating the length of the crack ãₙ₊₁=ãₙ+Δãₙ by using an integration scheme
$$\begin{matrix}{\tilde{a}}_{n + 1} = {\tilde{a}}_{n} + \frac{d {\tilde{a}}_{1}}{6} + \frac{d {\tilde{ a}}_{2}}{3} + \frac{d {\tilde{a}}_{3}}{3} + \frac{d {\tilde{a}}_{4}}{6} & ( 17 ) \\ d {\tilde{a}}_{1} = d Nf ( Δ {K}_{n} ) & ( 18 ) \\ d {\tilde{a}}_{2} = d Nf ( Δ {K}_{n} + \frac{1}{2} \frac{Δ {K}_{n}}{2 {\tilde{a}}_{n}} d {\tilde{a}}_{1} ) & ( 19 ) \\ d {\tilde{a}}_{3} = d Nf ( Δ {K}_{n} + \frac{1}{2} \frac{Δ {K}_{n}}{2 {\tilde{a}}_{n}} d {\tilde{a}}_{2} ) & ( 20 ) \\ d {\tilde{a}}_{4} = d Nf ( Δ {K}_{n} + \frac{Δ {K}_{n}}{2 {\tilde{a}}_{n}} d {\tilde{a}}_{3} ) , & ( 21 )\end{matrix}$$
with Δãₙ designating the increase in the crack size, N designating the number of cycles, and K designating the stress intensity factor.

2. The method as claimed in claim 1, further comprising determining the stress intensity factor by experimentally determined measured data.

3. The method as claimed in claim 1, further comprising determining the stress intensity factor by a geometry factor Y(a) and a stress σ.

4. The method as claimed in claim 3, further comprising determining a range of the stress intensity factor ΔK by a geometry factor Y(a) and a stress range Δσ in accordance with
ΔK=Δσ\sqrt{π}Y(a) (2).

5. The method as claimed in claim 1, wherein the function f is defined as a positively monotonically increasing function and/or the crack length is defined as a≧0, and/or the geometry factor is defined as Y≧0, and/or the stress range is defined as Δσ≧0.

6. The method as claimed in claim 1, further comprising estimating the crack length of a crack in a component of a gas turbine.

7. The method as claimed in claim 6, further comprising estimating the crack length of a crack in a component of a rotor of a gas turbine.

8. A method for determining the probability of failure of a component, comprising estimating the crack length of a crack in the component by a method as claimed in claim 1, and determining the probability of failure of the component on the basis of the estimated crack length.

9. A method for determining the probability of failure of a component in the context of a probabilistic fracture mechanics evaluation of the component comprising performing the method of estimating the crack length of at least one crack of the component according to the method of claim 1.

10. A method for operating a turbine, comprising:
inspecting at least one component of the turbine for the presence of at least one crack or defect;
if a crack or defect is, found by the inspection, determining an initial length of the crack or defect;
estimating a further length of the crack at a second instant in accordance with a method as claimed in claim 1; and
if the estimated crack length reaches or exceeds a defined limit value, replacing and/or repairing the component at a defined instant.

11. The method as claimed in claim 10, further comprising if the estimated crack length reaches or exceeds a defined selection value, wherein the selection value is less than the limit value, subjecting the crack or defect to a more accurate inspection or estimation of the crack length.

12. The method as claimed in claim 10, wherein the turbine is a gas turbine or a steam turbine.

13. The method as claimed in claim 10, comprising at a point in time, replacing and/or repairing the component later than the second point in time determined in the context of the estimation of the crack size.
